(19) United States
(12) Patent Application Publication
(10) Pub. No.: US 2023/0332348 A1
(43) Pub. Date: Oct. 19, 2023

(54) SILICONE POLYETHER POLYMER TREATMENTS FOR FIBROUS SUBSTRATES

(71) Applicant: THE CHEMOURS COMPANY FC, LLC, WILMINGTON, DE (US)

(72) Inventors: JOHN CHRISTOPHER SWOREN, LINCOLN UNIVERSITY, PA (US); GERALD ORONDE BROWN, SWEDESBORO, NJ (US); CHARLES K. KARANJA, NEWARK, DE (US); AMY LIZABETH WARREN, SWEDESBORO, NJ (US)

(73) Assignee: THE CHEMOURS COMPANY FC, LLC, WILMINGTON, DE (US)

(21) Appl. No.: 18/025,427

(22) PCT Filed: Sep. 7, 2021
(86) PCT No.: PCT/US2021/049274

§ 371 Date: Mar. 9, 2023

Related U.S. Application Data
(60) Provisional application No. 63/075,937, filed on Sep. 9, 2020.

(51) Int. Cl. D06M 15/647; C08G 77/46; C08L 83/12; D06M 13/328; D06M 13/188; D06M 15/263; D06M 15/248

(52) U.S. Cl. CPC D06M 15/647; C08G 77/46; C08L 83/12; D06M 13/328; D06M 13/188; D06M 15/263; D06M 15/248; D06M 2200/12; D06M 2200/01; D06M 2101/06

(57) ABSTRACT

Described is a fibrous substrate treatment composition having a) 20-99.5% by weight of a silicone polyether polymer and b) 0.5-4% by weight of a cationic surfactant or a mixture of cationic and nonionic surfactant; wherein the silicone polyether polymer has 6-100% by weight of formula (I) or (II) and 0-94% by weight of repeat units from ethylenically unsaturated comonomers;

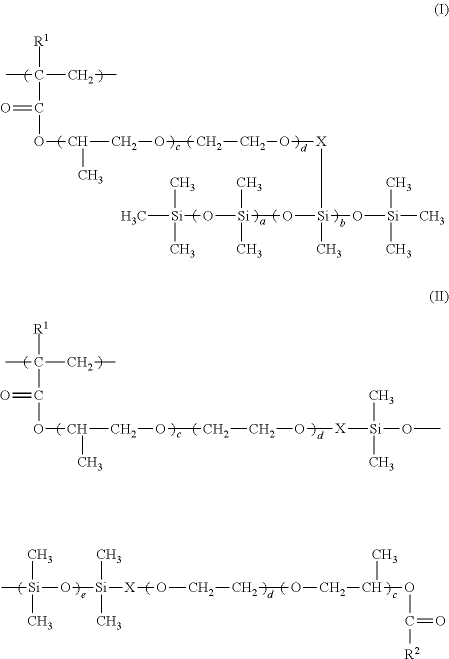

wherein a and b are integers of 1 to 40 where a+b is an integer of at least 2; c and d are integers of 0 to 20; e is an integer of 1 to 40; X is a linear or branched C₁-C₄ alkylene group; R¹ is a C₁-C₄ alkyl group; and R² is —C(R¹)═CH₂ or polymer backbone unit —[C(R¹)—CH₂]— bonded at C(R¹). Treatments exhibit improved balance of water repellency and oily stain release performance.

### FIELD OF THE INVENTION

Silicone polyether polymer compositions are employed as coating or finishing agents to provide surface effects to fibrous substrates.

### BACKGROUND OF THE INVENTION

Various compositions are known to be useful as treating agents to provide water repellency and optionally stain release to textile substrates. Many such treating agents are fluorinated polymers and copolymers, or non-fluorinated polymers and copolymers. Non-fluorinated compounds are predominately polyacrylate-based or urethane-based copolymers.

Fluorinated polymer compositions are used in the preparation of a wide variety of surface treatment materials to provide surface effects to substrates. Many such compositions are fluorinated surfactants which contain predominantly eight or more carbons in the perfluoroalkyl chain to provide the desired properties. Honda, et al., in Macromolecules, 2005, 38, 5699-5705 teach that for perfluoroalkyl chains of greater than 8 carbons, orientation of the perfluoroalkyl groups, designated R_{f} groups, is maintained in a parallel configuration while for such chains having 6 or less carbons, reorientation occurs. This reorientation is recited to decrease surface properties such as contact angle. Thus, compounds containing shorter perfluoroalkyl chains or having no fluorine content have traditionally exhibited lower performance.

### BRIEF SUMMARY OF THE INVENTION

The need exists for compositions that provide surface effects to fibrous substrates, where performance of water repellency is balanced with oily stain release properties. The present invention meets these needs.

The present invention relates to a treated substrate comprising a fibrous substrate and a treatment composition applied on the fibrous substrate, wherein the treatment composition comprises a) about 20-99.5% by weight of a silicone polyether polymer, and b) about 0.5-4% by weight of at least one surfactant selected from at least one cationic surfactant or a mixture of at least one cationic and at least one nonionic surfactant, all based on the total dry weight of the treatment composition; wherein the silicone polyether polymer has about 6 to about 100% by weight of repeat units from formula (I) or formula (II) and about 0% to about 94% by weight of repeat units from ethylenically unsaturated comonomers, all based on the total weight of the polymer;

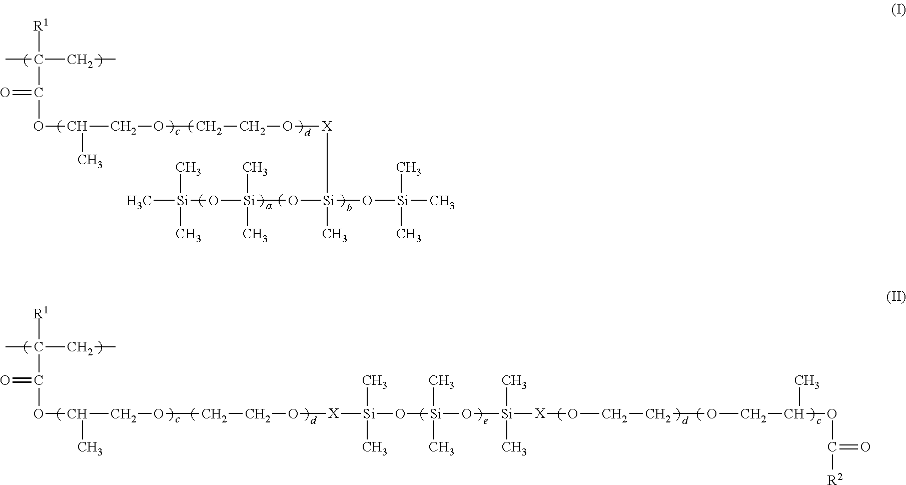

wherein a and b are independently integers of 1 to 40 where a+b is an integer of at least 2; c and d are independently integers of 0 to 20; e is an integer of 1 to 40; X is a linear or branched C₁-C₄ alkylene group; R¹ is a C₁-C₄ alkyl group; and R² is —C(R¹)═CH₂ or polymer backbone unit —[C(R¹)—CH₂]— bonded at C(R¹); provided that if c+d is 0, then the silicone polyether polymer has repeat units from at least one ethylenically unsaturated comonomer having at least one pendant alkoxylate group.

The present invention further comprises a process of providing a surface effect to a substrate comprising contacting a treatment composition with a fibrous substrate, wherein the treatment composition comprises a) about 20-99.5% by weight of a silicone polyether polymer, and b) about 0.5-4% by weight of at least one surfactant selected from at least one cationic surfactant or a mixture of at least one cationic and at least one nonionic surfactant all based on the total dry weight of the treatment composition; wherein the silicone polyether polymer has about 6 to about 100% by weight of repeat units from formula (I) or formula (II) as shown above and about 0% to about 94% by weight of repeat units from ethylenically unsaturated comonomers, all based on the total weight of the polymer; wherein a and b are independently integers of 1 to 40 where a+b is an integer of at least 2; c and d are independently integers of 0 to 20; e is an integer of 1 to 40; X is a linear or branched C₁-C₄ alkylene group; R¹ is a C₁-C₄ alkyl group; and R² is —C(R¹)═CH₂ or polymer backbone unit —[C(R¹)—CH₂]— bonded at C(R¹); provided that if c+d is 0, then the silicone polyether polymer has repeat units from at least one ethylenically unsaturated comonomer having at least one pendant alkoxylate group.

### DETAILED DESCRIPTION OF THE INVENTION

Features of the embodiments of the present invention as described in the Detailed Description of the Invention can be combined in any manner.

The present invention provides treated fibrous substrates having improved water repellency, oil or stain repellency, cleanability and/or other surface effects. The treatment compositions provide a balance of hydrophobic properties and oleophobic properties without the use of fluorine. The coatings formed are durable, by which is meant that the coatings are lasting films that are not readily removed by water or cleaning agents. In one aspect, the coatings are not soluble or dispersable in water or cleaning agents once they are dry, and in another aspect, the coatings withstand multiple cleanings without loss of performance.

In one aspect, the present invention relates to a treated substrate comprising a fibrous substrate and a treatment composition applied on the fibrous substrate, wherein the treatment composition comprises a) about 20-99.5% by weight of a silicone polyether polymer, and b) about 0.5-4% by weight of at least one surfactant selected from at least one cationic surfactant or a mixture of at least one cationic and at least one nonionic surfactant, all based on the total dry weight of the treatment composition; wherein the silicone polyether polymer has about 6 to about 100% by weight of repeat units from formula (I) or formula (II) and about 0% to about 94% by weight of repeat units from ethylenically unsaturated comonomers, all based on the total weight of the polymer;

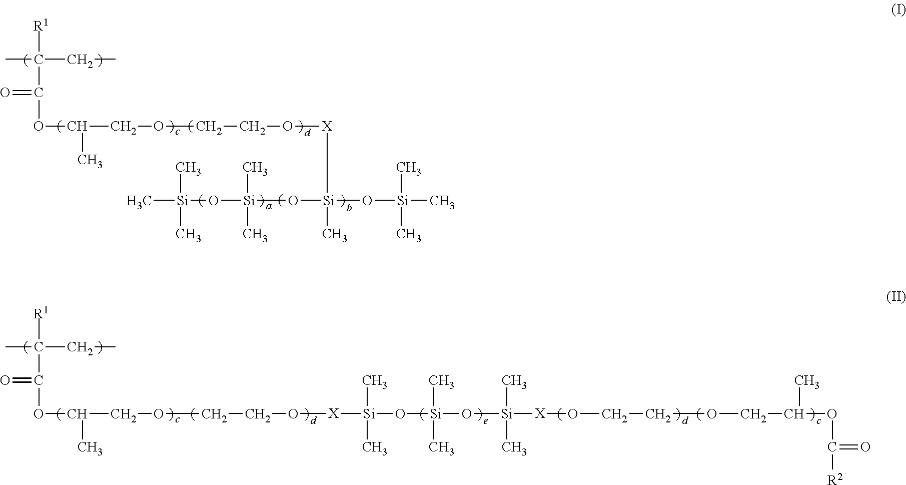

wherein a and b are independently integers of 1 to 40 where a+b is an integer of at least 2; c and d are independently integers of 0 to 20; e is an integer of 1 to 40; X is a linear or branched C₁-C₄ alkylene group; R¹ is a C₁-C₄ alkyl group; and R² is —C(R¹)═CH₂ or polymer backbone unit —[C(R¹)—CH₂]— bonded at C(R¹); provided that if c+d is 0, then the silicone polyether polymer has repeat units from at least one ethylenically unsaturated comonomer having at least one pendant alkoxylate group.

The term “copolymer” is intended to mean a polymeric compound having at least two different monomeric units. The term includes terpolymers and polymers having more than three different monomeric units. The —(OCH₂CH₂)— of formula (I) or (II) represents oxyethylene groups (EO) and —(OCH₂CH(CH₃))— represents oxypropylene groups (PO). These compounds can contain only EO groups, only PO groups, or mixtures thereof in random or block configuration. These compounds can also be present as a tri-block copolymer designated PEG-PPG-PEG (polyethylene glycol-polypropylene glycol-polyethylene glycol), for example. In one embodiment, c+d is 1 to 30; in another embodiment, c+d is 1 to 15; and in a third embodiment, c+d is 1 to 12. In one aspect, when c+d is 0, the ethylenically unsaturated comonomer has 1-20 pendant alkoxylate groups; in another aspect, when c+d is 0, the ethylenically unsaturated comonomer has 2-20 pendant alkoxylate groups; an in a third aspect, when c+d is 0, the ethylenically unsaturated comonomer has 3-20 pendant alkoxylate groups.

The silicone polyether segment of the polymer may be part of a pendant endgroup of a (meth)acrylic repeat unit, such as in formula (I), or it may be a divalent linear segment between two (meth)acrylic repeat units, such as in formula (II). Polymers with repeat units of formula (I) are formed from free radical polymerization of silicone polyether (meth)acrylate compounds with or without comonomers, while repeat units of formula (II) are formed from free radical polymerization of silicone polyether di(meth)acrylate compounds with or without comonomers. The monomers to form the repeat units are found, for example, under the tradename Silmer® ACR or Silmer® MACR. The compounds have significant hydrophilic content by the incorporation of the silicone polyether monomeric unit. Such polymers may optionally include additional repeat units, such as alkyl siloxane units having alkyl groups of C₁-C₅. In formula (I), a and b may independently be integers of 1 to 40; in another aspect, a and b may independently be integers of 2 to 40, and in a third aspect, a and b may independently be integers of 3 to 40. In one aspect, b is at least 1; in another aspect, b is at least 2, and in a third aspect, b is at least 3. In one aspect, a+b is at least 2; in another aspect, a+b is at least 4, and in a third aspect, a+b is at least 6. In formula (II), e is an integer of 1 to 40; in another aspect, e is an integer of 2 to 40; and in a third aspect, e is an integer of 3 to 40.

The polymers of formula (II) are formed by silicone diacrylate monomers of formula (III):

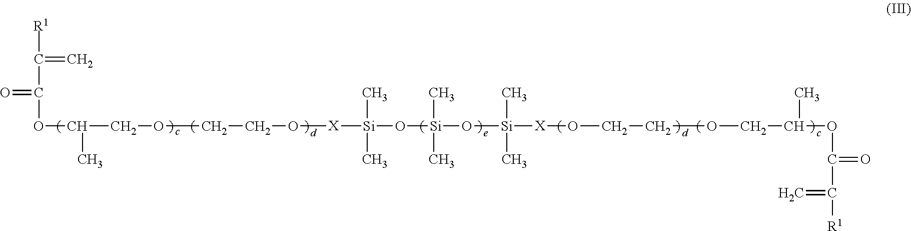

where R¹, c, d, X, and e are defined as above. In formula (II), R² may either be a polymerizable unit —C(R¹)═CH₂ or a polymer backbone unit —[C(R¹)—CH₂]— bonded at C(R¹). The polymer backbone unit —[C(R¹)—CH₂]—bonded at C(R¹) results from a polymerizable unit —C(R¹)═CH₂ reacting with another polymerizable unit —C(R¹)═CH₂ of a silicone diacrylate monomer.

For either formula (I) or (II), if c+d is 0, then the silicone polyether polymer has repeat units from at least one ethylenically unsaturated comonomer having at least one pendant alkoxylate group. This comonomer may be any ethylenically unsaturated compound having one or more pendant alkoxylate groups such as, but not limited to, (meth)acrylate compounds, (meth)acrylamide compounds, or vinyl compounds. For example, the ethylenically unsaturated compounds may have 1-40 pendant alkoxylate groups; in another aspect, the ethylenically unsaturated compound has 1-20 pendant alkoxylate groups; and in another aspect, the ethylenically unsaturated compound has 1-10 pendant alkoxylate groups. Alkoxylate groups may be, for example, ethylene oxide, propylene oxide, butylene oxide, or mixtures thereof.

The silicone polyether polymer may be a homopolymer, having 100% repeat units from formula (I) or formula (II). In another aspect, the silicone polyether polymer may be a copolymer having repeat units from formula (I) or formula (II) and repeat units from one or more comonomers. When a comonomer is used, the silicone polyether polymer may be in the form of a random copolymer, block copolymer, or other configuration of copolymer. The comonomer may be any suitable ethylenically unsaturated comonomer. For example, the comonomer may be selected from alkoxylated (meth)acrylates, hydroxyalkyl (meth)acrylates, glycidyl (meth)acrylates, cyclic hydrocarbon (meth)acrylates, linear or branched alkyl (meth)acrylates, vinylidene halide, vinyl halide, vinyl acetate, diacetone (meth)acrylamide, alkoxylated (meth)acrylamides, hydroxyalkyl (meth)acrylamides, glycidyl (meth)acrylamides, cyclic hydrocarbon (meth)acrylamides, linear or branched alkyl (meth)acrylamides, or mixtures thereof. When c+d is 0, the ethylenically unsaturated monomer having at least one pendant group may be selected from alkoxylated (meth)acrylates, hydroxyalkyl (meth)acrylates, alkoxylated (meth)acrylamides, hydroalkyl (meth)acrylamides, or mixtures thereof.

The silicone polyether polymer has about 6-100% by weight repeat units from formula (I) or formula (II) and 0-94% repeat units from ethylenically unsaturated comonomers; in another aspect, the silicone polyether polymer has about 10-100% by weight repeat units from formula (I) or formula (II) and 0-90% by weight repeat units from ethylenically unsaturated comonomers; in another aspect, the silicone polyether polymer has about 20-100% by weight repeat units from formula (I) or formula (II) and 0-80% by weight repeat units from ethylenically unsaturated comonomers; in another aspect, the silicone polyether polymer has about 30-100% by weight repeat units from formula (I) or formula (II) and 0-70% by weight repeat units from ethylenically unsaturated comonomers; in another aspect, the silicone polyether polymer has about 40-100% by weight repeat units from formula (I) or formula (II) and 0-60% by weight from ethylenically unsaturated comonomers; and in another aspect, the silicone polyether polymer has about 60-100% by weight repeat units from formula (I) or formula (II) and 0-40% by weight from ethylenically unsaturated comonomers; all based on the total weight % of the silicone polyether polymer.

In another aspect, comonomers are positively present. In one aspect, the silicone polyether polymer has about 6-99% by weight repeat units from formula (I) or formula (II) and 1-94% repeat units from ethylenically unsaturated comonomers; in another aspect, the silicone polyether polymer has about 10-99% by weight repeat units from formula (I) or formula (II) and 1-90% by weight repeat units from ethylenically unsaturated comonomers; in another aspect, the silicone polyether polymer has about 20-99% by weight repeat units from formula (I) or formula (II) and 1-80% by weight repeat units from ethylenically unsaturated comonomers; in another aspect, the silicone polyether polymer has about 30-99% by weight repeat units from formula (I) or formula (II) and 1-70% by weight repeat units from ethylenically unsaturated comonomers; in another aspect, the silicone polyether polymer has about 40-99% by weight repeat units from formula (I) or formula (II) and 1-60% by weight from ethylenically unsaturated comonomers; and in another aspect, the silicone polyether polymer has about 60-99% by weight repeat units from formula (I) or formula (II) and 1-40% by weight from ethylenically unsaturated comonomers; all based on the total weight % of the silicone polyether polymer.

In one embodiment, the silicone polyether polymer may have repeat units from more than two comonomers. For example, the silicone polyether polymer may have repeat units from formula (I) or formula (II), as well as repeat units from copolymerizing at least one hydrophilic monomer selected from alkoxylated (meth)acrylates, alkoxylated (meth)acrylamides, hydroxyalkyl (meth)acrylates, hydroxyalkyl (meth)acrylamides, glycidyl (meth)acrylates, or mixtures thereof; and at least one additional monomer selected from cyclic hydrocarbon (meth)acrylates, linear or branched alkyl (meth)acrylates, vinylidene halide, vinyl halide, vinyl acetate, diacetone (meth)acrylamide, glycidyl (meth)acrylamides, cyclic hydrocarbon (meth)acrylamides, linear or branched alkyl (meth)acrylamides, or mixtures thereof. In one aspect, the silicone polyether polymer has about 40-89% by weight repeat units from formula (I) or formula (II), about 1-20% by weight repeat units from hydrophilic monomers, and about 10-40% by weight repeat units from additional monomers cited above; in another aspect, the silicone polyether polymer has about 50-85% by weight repeat units from formula (I) or formula (II), about 5-20% by weight repeat units from hydrophilic monomers, and about 10-30% by weight repeat units from additional monomers cited above; and in a third aspect, the silicone polyether polymer has about 60-75% by weight repeat units from formula (I) or formula (II), about 10-15% by weight repeat units from hydrophilic monomers, and about 15-25% by weight repeat units from additional monomers cited above; all based on the total weight of the ethylenically unsaturated comonomers. In one embodiment, the silicone polyether polymer is soluble or dispersible in water at 1% by weight at room temperature.

In one aspect, the silicone polyether polymer has a molecular weight Mₙ of at least 5,000 Da; in another aspect, the molecular weight Mₙ is at least 10,000 Da; and in another aspect, the molecular weight Mo is at least 20,000 Da. Molecular weight Mₙ and M_{w} can be measured by a size exclusion chromatographer using a calibration standard. For example, polymer solutions are diluted, allowed to sit at ambient temperature for 4 days, and passed through 0.2 μm syringe filter. The polymer solution is injected into a mobile phase through an AGILENT 1100 system equipped with a G1362A refractive index detector and pumped at 1.0 mL/min for 40 min through two PSS SUPREMA columns (10,000 A, 10 μm; 1,000 A, 5 μm, both 8×300 mm) held at 30° C.

The at least one surfactant may be any cationic surfactant or any mixture of at least one cationic surfactant with at least one nonionic surfactants. Because anionic surfactants are not beneficial in these treatment compositions, in one aspect, the treatment composition has less than 0.01% of a anionic surfactant. Cationic surfactants include those used in textile applications, including but not limited to salts of protonated amines; quarternary ammonium salts; or alkyl amine oxides. Protonated amines are formed by mixing an amine compound with an acid such as hydrochloric acid or acetic acid. Amine compound examples include alkyl dimethyl amines, dialkyl methyl amines, alkyl ethoxylated amines, alkyl diamines, and their respective ethoxylates, including those compounds sold under the brand Armeen®. Quarternary amine salts are typically produced by the alkylation of amines, including those listed above. Alkylating agents include but are not limited to methyl chloride, dimethyl sulfate, diethyl sulfate, and benzyl chloride. Specific examples include alkyl trimethyl ammonium salts; dialkyl dimethyl ammonium salts, specifically dialkyl dimethyl ammonium chloride; alkyl methyl ethoxylated ammonium; alkyl dimethyl benzyl ammonium; dialkyl methyl benzyl ammonium; alkyl, alkylamidomethyl, and carboalkoxy pyridinium (with and without ring substitution); alkyl quinolinium; alkyl isoquinolinium; N,N-alkyl methyl pyrollidinium; amidoimidazolinium; amido ammonium; and quaternary ammonium salts of alkyl diamines and their ethoxylates. Some of these compounds are sold under the brand Arquad®. Alkyl amine oxides include compounds such as alkyl dimethyl amine oxide, dialkyl methyl amine oxide, and alkyl diamine oxide.

Thus, the cationic surfactant of any category is typically selected from a protonated alkyl dimethyl amine salt, protonated dialkyl methyl amine salt, protonated alkyl ethoxylated amine salt, protonated alkyl diamine salt, protonated alkyl ethoxylated diamine salt, alkyl trimethyl ammonium salt, dialkyl dimethyl ammonium salt, alkyl methyl ethoxylated ammonium salt, alkyl dimethyl benzyl ammonium salt, dialkyl methyl benzyl ammonium salt, alkyl pyridinium salt, alkylamidomethyl pyridinium salt, carboalkoxy pyridinium salt, alkyl quinolinium salt, alkyl isoquinolinium salt, N,N-alkyl methyl pyrollidinium salt, amidoimidazolium salt, amido ammonium salt; quaternary ammonium salt of alkyl diamine; ethoxylate of quaternary ammonium salt of alkyl diamine; alkyl dimethyl amine oxide; dialkyl methylamine oxide; and alkyl diamine oxide.

Nonionic surfactants include those used in textile applications, including but not limited to alkoxylate condensate compounds. Examples include alkoxylate condensates with fatty acid alkanol amides such as amides of fatty acids and diethanol amine; with alkyl phenols such as isooctylphenol; with a fatty acid such as a stearate; with a linear fatty alcohol; with a branched fatty alcohol; and with poly(oxypropylene) block-copolymers.

In one aspect, the treatment composition comprises about 20-99.5% by weight of the silicone polyether polymer; in a second aspect, about 40-99.5% by weight of the silicone polyether polymer; and in a third aspect, about 50-99.5% by weight of the silicone polyether polymer, all based on the total dry weight of the treatment composition. In one aspect, the treatment composition comprises about 0.5-4% by weight of at least one surfactant as defined above; in another aspect, about 0.5-3.5% by weight of the surfactant; and in a third aspect, about 0.5-3% by weight of the surfactant, all based on the total dry weight of the treatment composition. The coating composition may also contain a liquid carrier that is not present once the coating is dry or solid, such as water or organic solvent. In one aspect, the liquid carrier is water. Additional components present in the coating composition that make up the balance of the total dry weight of the treatment composition may include but are not limited to surface effect agents; pigments such as dyes or TiO₂; surfactants; curing agents; pH adjustors; or wetting agents. The term “total dry weight of the coating” is used to mean the sum of the coating components that would remain once the aqueous, solvent, or other liquid components evaporated. In other words, it is the sum of the non-aqueous, non-solvent, and non-volatile components of the coating.

The coating composition may further comprise a hydrophobic surface effect agent, which may be fluorinated or non-fluorinated. For example, the coating composition may further comprise a fatty acid ester of cyclic or acyclic polyols, fatty esters of polycarboxylic acids, hydrophobic non-fluorinated (meth)acrylic polymers, partially fluorinated urethanes, hydrophobic non-fluorinated urethanes, partially fluorinated (meth)acrylic polymers or copolymers, partially fluorinated (meth)acrylamide polymers or copolymers, fluorinated phosphates, fluorinated ethoxylates, fluorinated or non-fluorinated organosilanes, silicones, waxes, including parafins, and mixtures thereof. In one embodiment, the treatment composition is non-fluorinated. In another aspect, a fluorinated hydrophobic surface effect agent is used to supplement the silicone polyether polymer. In one aspect, the amount of silicone polyether polymer is greater than the amount of hydrophobic surface effect agent.

In one embodiment, the treatment composition comprises a) about 20-95% by weight of a silicone polyether polymer, b) about 0.5-4% by weight of at least one surfactant, and c) about 1-79.5% by weight of a hydrophobic surface effect agent, all based on the total dry weight of the treatment composition. In another embodiment, the treatment composition comprises a) about 20-86% by weight of a silicone polyether polymer, b) about 0.5-4% by weight of at least one surfactant, and c) about 10-79.5% by weight of a hydrophobic surface effect agent, all based on the total dry weight of the treatment composition; and in a third embodiment, the treatment composition comprises a) about 39.5-86% by weight of a silicone polyether polymer, b) about 0.5-4% by weight of at least one surfactant, and c) about 10-60% by weight of a hydrophobic surface effect agent, all based on the total dry weight of the treatment composition. Hydrophobic surface effect agents provide surface effects such as moisture control, strength, anti-slip, anti-static, anti-snag, anti-pill, stain repellency, stain release, soil repellency, soil release, water repellency, oil repellency, odor control, antimicrobial, sun protection, anti-blocking, cleanability, dust resistance, leveling, corrosion resistance, acid resistance, anti-fog, or anti-ice, and similar effects. Some stain release and soil release agents are hydrophilic and include compounds such as polymethyl acrylates or hydrophilic urethanes.

Suitable fatty acid esters of cyclic or acyclic polyols include reaction products of fatty acids with cyclic or acyclic sugar alcohols, or pentaerythritols including dipentaerythritol, which may also contain internal alkoxide units. Fatty esters of polycarobyxlic acids include reaction products of long-chain alkanols with polycarboxylic acids. Examples of polyols and polycarboxylic acids include but are not limited to glucose, 1,4-anhydro-D-glucitol, 2,5-anhydro-D-mannitol, 2,5-anhydro-L-iditol, isosorbide, sorbitan, glyceraldehyde, erythrose, arabinose, ribose, arabinose, allose, altrose, mannose, xylose, lyxose, gulose, glactose, talose, fructose, ribulose, mannoheptulose, sedohelptulose, threose, erythritol, threitol, glucopyranose, mannopyranose, talopyranose, allopyranose, altropyranose, idopyranose, gulopyranose, glucitol, mannitol, erythritol, sorbitol, arabitol, xylitol, ribitol, galactitol, fucitol, iditol, inositol, pentaerythritol, dipentaerythritol, volemitol, gluconic acid, glyceric acid, xylonic acid, galactaric acid, ascorbic acid, citric acid, gluconic acid lactone, glyceric acid lactone, xylonic acid lactone, glucosamine, galactosamine, or mixtures thereof. Suitable fatty acids include, but are not limited to, caprylic acid, capric acid, lauric acid, mysteric acid, palmitic acid, stearic acid, arachidic acid, behenic acid, lignoceric acid, palmitoleic acid, lineolic acid, oleic acid, erucic acid, alkoxylated versions of these acids, and mixtures thereof. In one embodiment, the fatty acid esters or fatty esters contain linear or branched alkyl groups having 11 to 29 carbons, and in another embodiment, the contain linear or branched alkyl groups having 17 to 21 carbons. Particular examples include mono-substituted, di-substituted, or tri-substituted sorbitans, such as SPAN, sorbitan stearates, or sorbitan behenins; mono-, di-, and tri-substituted sorbitans derived from palmitoleic acid, lineolic acid, arachidonic acid, and erucic acid; polysorbates such as polysorbate tristearate and polysorbate monostearate; citrates that are mono-substituted, di-substituted, or tri-substituted with alkyl groups; pentaerythriol esters that are mono-substituted, di-substituted, or tri-substituted with alkyl groups.

Superior properties, along with desirable properties of low yellowing and good durability, are imparted to articles by the combination of the silicone polether polymers with hydrophobic surface effect agents before application to the articles. These combined blends are applied to the articles in the form of a dispersion in water or other solvent either before, after or during the application of other treatment chemicals.

Other useful hydrophobic surface effect agents include fluorinated polymers that provide repellency properties to the surface of treated substrates. These include fluorochemical compounds or polymers containing one or more fluoroaliphatic groups (designated here as R_{f} groups) which are fluorinated, stable, inert, and non-polar, preferably saturated, monovalent, and both oleophobic and hydrophobic. The R_{f} groups contain at least 3 carbon atoms, preferably 3 to 20 carbon atoms, more preferably 4 to 12 carbon atoms, and most preferably about 4 to about 6 carbon atoms. The R_{f} groups may contain straight or branched chain or cyclic fluorinated alkylene groups or combinations thereof. The terminal portion of the R_{f} groups is preferably a perfluorinated aliphatic group of the formula CₙF₂ₙ₊₁ wherein n is from about 3 to about 20. Examples of fluorinated polymer treating agents are CAPSTONE and ZONYL available from The Chemours Company, Wilmington, DE; ASAHI GARD from Asahi Glass Company, Ltd., Tokyo, Japan; UNIDYNE from Daikin America, Inc., Orangeburg, NY; SCOTCHGARD from 3M Company, St. Paul, MN; and NANO TEX from Nanotex, Emeryville, CA.

Examples of such fluorinated polymers include R_{f}-containing polyurethanes and poly(meth)acrylates. Especially preferred are copolymers of fluorochemical (meth)acrylate monomers with a co-polymerizable monovinyl compound or a conjugated diene. The co-polymerizable monovinyl compounds include alkyl (meth)acrylates, vinyl esters of aliphatic acids, styrene and alkyl styrene, vinyl halides, vinylidene halides, alkyl esters, vinyl alkyl ketones, and acrylamides. The conjugated dienes are preferably 1,3-butadienes. Representative compounds within the preceding classes include the methyl, propyl, butyl, 2-hydroxypropyl, 2-hydroxyethyl, isoamyl, 2-ethylhexyl, octyl, decyl, lauryl, cetyl, and octadecyl acrylates and methacrylates; vinyl acetate, vinyl propionate, vinyl caprylate, vinyl laurate, vinyl stearate, styrene, alpha methyl styrene, p-methylstyene, vinyl fluoride, vinyl chloride, vinyl bromide, vinylidene fluoride, vinylidene chloride, allyl heptanoate, allyl acetate, allyl caprylate, allyl caproate, vinyl methyl ketone, vinyl ethyl ketone, 1,3-butadiene, 2-chloro-1,3-butadiene, 2,3-dichloro-1,3-butadiene, isoprene, N-methylolacrylamide, N-methylolmethacrylamide, glycidyl acrylate, glycidyl methacrylate, amine-terminated (meth)acrylates, and polyoxy(meth)acrylates.

Hydrophobic non-fluorinated acrylic polymers include copolymers of monovinyl compounds, including alkyl (meth)acrylates, vinyl esters of aliphatic acids, styrene and alkyl styrene, vinyl halides, vinylidene halides, alkyl esters, vinyl alkyl ketones, and acrylamides. The conjugated dienes are preferably 1,3-butadienes. Representative compounds within the preceding classes include the methyl, propyl, butyl, 2-hydroxypropyl, 2-hydroxyethyl, isoamyl, 2-ethylhexyl, octyl, decyl, lauryl, cetyl, and octadecyl acrylates and methacrylates; vinyl acetate, vinyl propionate, vinyl caprylate, vinyl laurate, vinyl stearate, styrene, alpha methyl styrene, p-methylstyene, vinyl fluoride, vinyl chloride, vinyl bromide, vinylidene fluoride, vinylidene chloride, allyl heptanoate, allyl acetate, allyl caprylate, allyl caproate, vinyl methyl ketone, vinyl ethyl ketone, 1,3-butadiene, 2-chloro-1,3-butadiene, 2,3-dichloro-1,3-butadiene, isoprene, N-methylolacrylamide, N-methylolmethacrylamide, glycidyl acrylate, glycidyl methacrylate, amine-terminated (meth)acrylates, and polyoxy(meth)acrylates.

Hydrophobic non-fluorinated urethanes include, for example, urethanes synthesized by reacting an isocyanate compound with the hydrophobic compounds described above as an alcohol reagent. These compounds are described in U.S. Pat. Nos. 10,138,392; 10,246,608. Hydrophobic non-fluorinated nonionic acrylic polymers include, for example, polymers made by polymerizing or copolymerizing an acrylic ester of the hydrophobic compounds described above. Such compounds are described in U.S. Pat. No. 9,915,025.

The silicone polyether polymer is generally formed by reacting the silicone polyether monomer along with optional comonomers and surfactant in water. The monomers and surfactant are emulsified using a blender, homogenizer, or other sheer mechanism. The contents are then heated and reacted in the absence of oxygen using a peroxide or other free radical initiator. In one aspect, the reaction silicone polyether polymer is formed in an aqueous reaction medium; in another aspect, the reaction medium contains less than 5% by weight of an organic solvent; in another aspect, the reaction medium contains less than 1% by weight of an organic solvent; and in another aspect, the reaction medium contains no organic solvent; all based on the total weight of the reaction contents. In another aspect, the silicone polyether polymer, surfactant, and optional surface effect agents may be effectively mixed to form the treatment composition by thoroughly stirring it in at room or ambient temperature. More elaborate mixing can be employed such as using a mechanical shaker or providing heat or other methods.

The coating composition of the present invention optionally further comprises additional components such as additional treating agents or finishes to achieve additional surface effects, or additives commonly used with such agents or finishes. One or more such treating agents or finishes can be combined with the blended composition and applied to the article. Other additives commonly used with such treating agents or finishes may also be present such as surfactants, pH adjusters, cross linkers, wetting agents, and other additives known by those skilled in the art. Further, other extender compositions are optionally included to obtain a combination of benefits.

In one aspect, the invention relates to a process of providing a surface effect to a substrate comprising contacting a treatment composition with a fibrous substrate, wherein the treatment composition comprises a) about 20-99.5% by weight of a silicone polyether polymer, and b) about 0.5-4% by weight of at least one surfactant selected from at least one cationic surfactant or a mixture of at least one cationic and at least one nonionic surfactant all based on the total dry weight of the treatment composition; wherein the silicone polyether polymer has about 6 to about 100% by weight of repeat units from formula (I) or formula (II) as shown above and about 0% to about 94% by weight of repeat units from ethylenically unsaturated comonomers, all based on the total weight of the polymer; wherein a and b are independently integers of 1 to 40 where a+b is an integer of at least 2; c and d are independently integers of 0 to 20; e is an integer of 1 to 40; X is a linear or branched C₁-C₄ alkylene group; R¹ is a C₁-C₄ alkyl group; and R² is —C(R¹)═CH₂ or polymer backbone unit —[C(R¹)—CH₂]— bonded at C(R¹); provided that if c+d is 0, then the silicone polyether polymer has repeat units from at least one ethylenically unsaturated comonomer having at least one pendant alkoxylate group. This embodiment may be combined with one or more of the previously described embodiments.

The contacting step may occur by applying the treatment composition in the form of an aqueous solution, aqueous dispersion, organic solvent solution or dispersion, or cosolvent solution or dispersion. The contacting step may occur by any conventional method, including but not limited to exhaustion, foam, flex-nip, nip, pad, kiss-roll, beck, skein, winch, liquid injection, overflow flood, brush, spraying, rolling, dip-squeeze, painting, dripping, immersing, powder coating, tumbling, or screen printing. Fibrous substrates include but are not limited to fibers, textiles including fabrics or fabric blends, paper, nonwovens, leather, or a combination thereof. By “fabrics” is meant natural or synthetic fabrics, or blends thereof, composed of fibers such as cotton, rayon, silk, wool, polyester, polypropylene, polyolefins, nylon, and aramids. By “fabric blends” is meant fabric made of two or more types of fibers. Typically these blends are a combination of at least one natural fiber and at least one synthetic fiber, but also can be a blend of two or more natural fibers or of two or more synthetic fibers.

The treatment compositions of the present invention applied to fibrous substrates optionally further comprise a blocked isocyanate to promote durability, added after copolymerization (i.e., as a blended isocyanate). An example of a suitable blocked isocyanate is PHOBOL XAN available from Huntsman Corp, Salt Lake City, UT. Other commercially available blocked isocyanates are also suitable for use herein. The desirability of adding a blocked isocyanate depends on the particular application for the copolymer. For most of the presently envisioned applications, it does not need to be present to achieve satisfactory cross-linking between chains or bonding to fibers. When added as a blended isocyanate, amounts up to about 20% by weight are added. When synthetic fabrics are treated, a wetting agent can be used, such as ALKANOL 6112 available from E. I. du Pont de Nemours and Company, Wilmington, DE. As a further example, when cotton or cotton-blended fabrics are treated, a wrinkle-resistant resin can be used such as PERMAFRESH EFC available from Emerald Carolina, LLC, Cahrlotte, NC. When nonwoven fabrics are treated, a wax extender can be employed such as FREEPEL 1225WR, available from Omnova Solutions Chester, SC. An antistat such as ZELEC KC, available from Stepan, Northfield, IL, or a wetting agent, such as hexanol, also are suitable.

The dispersions are generally applied to fibrous substrates by spraying, dipping, padding, or other well-known methods. After excess liquid has been removed, for example by squeeze rolls, the treated fibrous substrate is dried and then cured by heating, for example, to from about 100° C. to about 190° C., for at least 30 seconds, typically from about 60 to about 240 seconds. Such curing enhances oil-, water- and soil repellency and durability of the repellency. While these curing conditions are typical, some commercial apparatus may operate outside these ranges because of its specific design features.

In one embodiment, the contacting step occurs inside a laundry machine. This step may be practiced by any suitable method. For example, water is used to help disperse the coating composition, such as by a wash cycle or rinse cycle of the laundry machine. The water temperature used in the wash cycle or rinse cycle may be any temperature including cold, room temperature, warm, or hot. Methods of contacting the additive with the substrate include, but are not limited to, introducing the coating composition by pouring into the basin of the laundry machine, pouring the coating composition into a detergent or treating agent reservoir of the laundry machine, adding a dissolvable pouch containing the coating composition, or adding a controlled-coating composition may be introduced into an aqueous liquor and contacted with a fibrous substrate into a tub, bucket or sink, such as when washing fabrics by hand. In one aspect, the coating composition is part of a detergent composition, and the non-fluorinated compound forms a finish coating on the finished dry fabric.

In one embodiment, the coating composition is poured into the wash basin, or into a detergent or treating agent reservoir, of the laundry machine and the machine is programmed to run a wash cycle or rinse cycle. In one embodiment, the wash basin is partially filled with water, the laundry treatment composition or laundry additive composition is poured into the water, and the water is allowed to fill the wash basin. Detergent is then optionally added, the fibrous substrate is added to the wash basin, and the laundry machine is allowed to run a full wash or rinse cycle.

In one aspect, the method further comprises the step of heating the partially or completely coated article. For example, the treatment composition may be applied, and the treated article may be heated to melt, flow, dry, or otherwise fix the hydrophobic agent onto the article surface. In another aspect, the method further comprises the step of subjecting the coating composition to UV radiation. The final coating on the article surface will be a solidified, lasting, permanent coating. In another aspect, the method further comprises the step of solidifying the coating by drying, cooling, or allowing to cool. The liquid carrier may be dried by heating or air drying to allow for evaporation of the liquid carrier, thus leaving a permanent solid coating.

### EXAMPLES

All solvents and reagents, unless otherwise indicated, were purchased from Sigma-Aldrich, St. Louis, MO, and used directly as supplied.

Vazo™ 56 and Vazo™ 68 are free radical initiators; Zelan™ R3 is a durable water repellent agent; all available from The Chemours Company, Wilmington, DE.

Armeen® DM-18D is a dimethyl stearamine cationic surfactant; Arquad® 16-50 is a C16 trimethyl ammonium chloride cationic surfactant having a solids content of 50% by weight; and Arquad® 15-29 is a C16 trimethyl ammonium chloride cationic surfactant having a solids content of 27-30% by weight commercially available from Nouryon, Chicago, IL.

PHOBOL® XAN is a repellency extender; ULTRATEX® SI is a fabric softening additive; TURPEX® ACN is a fabric softening additive; INVADINE® PBN is a wetting agent; KNITTEX® 7636 is a crosslinking agent; all available from Huntsman Corp, Salt Lake City, UT.

C13-methacrylate is a linear C13 alkyl methacrylate, and IBOMA is an isobornyl methacrylate, both available from Evonik, Essen, Germany.

Blemmer® GLM is a glycerol monomethacrylate; Blemmer® PLE-200 is a lauroxy polyethyleneglycol methacrylate; Blemmer® AME-400 is a methoxy polyethylene glycol acrylate; Blemmer® ADE-400A is a polyalkylene glycol diacrylate; Blemmer® PE-90 is a hydroxy-terminal polyethylene glycol methacrylate; Blemmer® VMA-70 is a behenyl methacrylate; available from NOF, Tokyo, Japan.

CD9075 is an alkoxylated lauryl acrylate available from Sartomer, Exton, PA.

Tergitol® TMN-10 is a nonionic surfactant available from Dow Chemicals, Midland, MI.

Chemidex™ S is a cationic surfactant available from Lubrizol, Wickliffe, OH.

Silmer® ACR D208 is a multi-functional acrylate silicone polyether having a molecular weight of 3000; Silmer® ACR Di-1010 is a difunctional acrylate silicone polyether; Silmer© ACR Di-1508 is a linear silicone polyether diacrylate having a molecular weight of 1500; Silmer® ACR Di-2010-D is a difuntional acrylate silicone polyether; Silmer® MACR Di-1010 is a difunctional methacrylate silicone polyether; Silmer® MACR Di-1017 is a difunctional methacrylate silicone polyether; Silmer® MACR Di-1508 is a difunctional methacrylate silicone polyether; Silmer® MACR D212-CG is a multifunctional methacrylate silicone polyether; Silmer® MACR D208 is a multifunctional methacrylate silicone polyether; all commercially available from Siltech, Toronto, Canada.

The following test methods and materials were used in the examples herein.

Test Methods

### Test Method 1—Fabric Treatment

The fabrics treated in this study were 100% by weight khaki cotton twill available from SDL Atlas Textile Testing Solutions, Rock Hill, South Carolina 29732. The fabric was treated with the aqueous dispersions of various emulsion polymers using a conventional pad bath (dipping) process. The prepared concentrated dispersions were diluted with deionized water to achieve a pad bath having 60 g/L of the product in the bath. The fabric was padded in the bath, and the excess liquid was removed by squeeze rollers. The wet pickup was around 95% on the cotton substrate. The “wet pick up” is the weight of the bath solution of the emulsion polymer applied to the fabric, based on the dry weight of the fabric. The fabric was cured at approximately 165° C. for 3 minutes and allowed to “rest” after treatment and cure for at least 15 hours.

### Test Method 2—Spray Test

The dynamic water repellency of treated substrates was measured according to the American Association of Textile Chemists and Colorists (AATCC) TM-22. Samples are visually scored by reference to published standards, with a rating of 100 denoting no water penetration or surface adhesion. A rating of 90 denotes slight random sticking or wetting without penetration; lower values indicate progressively greater wetting and penetration. The dynamic water repellency test is a demanding and realistic test of water repellency

### Test Method 3—Stain Release

This test measures the ability of a fabric to release oily stains. Treated textiles are placed on a flat surface. Using an eyedropper, 5 drops of MAZOLA Corn Oil or mineral oil (0.2 mL) were placed onto the fabric to form 1 drop of oil. A weight (5 lb, 2.27 kg) is placed on top of the oil drop with a piece of glassine paper separating the oil drop. The weight was left in place for 60 seconds. After 60 seconds, the weight and glassine paper are removed. An initial rating was observed. The textiles were evaluated for residual stain of 1 to 5, 1 having the largest residual stain remaining and 5 being no stain residual was visible. The textiles samples were then washed using a automatic washer high for 12 minutes with AATCC 1993 Standard Reference Detergent WOB12 or granular detergent (100 g). The textiles were then dried on high for 45-50 minutes. The textiles were evaluated again for residual stain of 1 to 5 as stated above. In the examples below, stain release ratings of corn oil are designated by the term “Corn Oil”, and stain release ratings of mineral oil are designated by the term “Mineral Oil”. The term “HW” indicates a home wash cycle, and “10HW” indicates 10 home wash cycles were performed before the final rating was recorded.

### Comparative Example A

Cotton fabric was tested without any treatment composition, according to the test methods above.

### Examples 1-7

In a vessel, a silicone monomer (16.35% by weight), Armeen® DM18D (0.57% by weight), glacial acetic acid (0.46% by weight) and deionized water (81.73% by weight) were weighed. The contents were blended for 2 minutes on setting 3 in a blender. The mixture was added to a reactor, sparged with nitrogen, and heated to 55° C. Under a nitrogen blanket, initiator (Vazo™ 56, 0.03% by weight of total mixture in 0.86% by weight water) was added. The composition was mixed at 70° C. for 4 hours. The resulting polymer emulsion was applied onto fabric and tested according to the Test Methods above. In Example 4, the composition was applied to the substrate at 100 g/L from the pad bath.

### Examples 8-11

Example 1 was repeated, except Phobol® XAN was added into the pad bath at 5 g/L.

TABLE 1
Performance of Examples 1-11 and Comparative Example A

| | | Spray | | Corn Oil | | Mineral Oil | |
|---|---|---|---|---|---|---|---|
| | | Rating | | Rating | | Rating | |
| | | | 10 | | 10 | | 10 |
| Ex. | Silicone monomer | Initial | HW | Initial | HW | Initial | HW |
| A | None | 0 | 0 | 2.5 | 2.5 | 2.5 | 2.5 |
| 1 | Silmer ® ACR | 25 | | 3.75 | | 3.5 | |
| | D208 | | | | | | |
| 2 | Silmer ® ACR | 55 | | 3.5 | | 3.5 | |
| | Di-1010 | | | | | | |
| 3 | Silmer ® ACR | 60 | 50 | 4 | 3.5 | 3 | 3 |
| | Di-1508 | | | | | | |
| 4 | Silmer ® ACR | 60 | 50 | 3.5 | 4 | 3.5 | 3.5 |
| | Di-1508 | | | | | | |
| 5 | Silmer ® ACR | 50 | 50 | 3 | 3.25 | 2.75 | 3.25 |
| | Di-2010-D | | | | | | |
| 6 | Silmer ® MACR | 75 | | 4 | | 3.25 | |
| | Di-1010 | | | | | | |
| 7 | Silmer ® MACR | 25 | 25 | 4 | 4 | 3.5 | 3.5 |
| | Di-1017 | | | | | | |
| 8 | Silmer ® ACR | 0 | | 4.5 | | 2.5 | |
| | D208 | | | | | | |
| 9 | Silmer ® ACR | 50 | | 3.5 | | 3 | |
| | Di-1010 | | | | | | |
| 10 | Silmer ® ACR | 70 | 70 | 3.5 | 3.5 | 3 | 3.25 |
| | Di-1508 | | | | | | |
| 11 | Silmer ® ACR | 50 | | 4 | | 3 | |
| | Di-2010-D | | | | | | |

### Comparative Example B

In a vessel, Silmer® ACR Di-1508 (16.52% by weight) and deionized water (85.58% by weight) were weighed. The contents were blended for 2 minutes on setting 3 in a blender. The mixture was added to a reactor, sparged with nitrogen, and heated to 55° C. Under a nitrogen blanket, initiator (Vazo™ 56, 0.04% by weight of total mixture in 0.87% by weight water) was added. The composition was mixed at 70° C. for 4 hours. The resulting polymer gelled and was not able to be tested for performance.

### Comparative Example C

In a vessel, Silmer® ACR Di-1508 (13.14% by weight), 7EO MA (3.29% by weight), Armeen® DM18D (0.28% by weight), glacial acetic acid (0.23% by weight) and deionized water (82.15% by weight) were weighed. The contents were blended for 2 minutes on setting 3 in a blender. The mixture was added to a reactor, sparged with nitrogen, and heated to 55° C. Under a nitrogen blanket, initiator (Vazo™ 56, 0.04% by weight of total mixture in 0.86% by weight water) was added. The composition was mixed at 70° C. for 4 hours. The resulting polymer emulsion was applied onto fabric and tested according to the Test Methods above.

### Examples 12-13

Comparative Example C was repeated, using the amounts listed in Table 2. Example 12 used Chemidex® S in place of Armeen® DM18D. The resulting polymer emulsions were applied to fabric and tested according to the Test Methods above.

TABLE 2
Components of Examples 12-13

| Component (% by weight) | 12 | 13 |
|---|---|---|
| Silmer ® ACR Di-1508 | 12.94 | 13.08 |
| 7EO MA | 3.24 | 3.27 |
| Surfactant | 1.12 | 0.57 |
| Glacial acetic acid | 0.91 | 0.46 |
| Deionized water | 80.90 | 81.73 |
| Vazo ™ 56 | 0.03 | 0.03 |
| Deionized water | 0.85 | 0.86 |

### Examples 14-15

Examples 12-13 were repeated, except Phobol® XAN was added into the pad bath at 5 g/L.

TABLE 3
Performance of Examples 12-15 and Comparative Example C

| | | Spray | | Corn Oil | | Mineral Oil | |
|---|---|---|---|---|---|---|---|
| | | Rating | | Rating | | Rating | |
| | | | 10 | | 10 | | 10 |
| Ex. | Surfactant | Initial | HW | Initial | HW | Initial | HW |
| C | Armeen ® DM18D | 50 | | 3.5 | | 3.5 | |
| 12 | Chemidex ® S | 50 | | 3.5 | | 2.5 | |
| 13 | Armeen ® DM18D | 70 | 70 | 4 | 4 | 3.5 | 3.5 |
| 14 | Chemidex ® S | 50 | | 4 | | 3 | |
| 15 | Armeen ® DM18D | 60 | | 3.5 | | 3 | |

### Example 16

In a vessel, Silmer® ACR Di-2010-D (13.08% by weight), 7EO MA (3.27% by weight), Armeen® DM18D (0.57% by weight), glacial acetic acid (0.46% by weight) and deionized water (81.73% by weight) were weighed. The contents were blended for 2 minutes on setting 3 in a blender. The mixture was added to a reactor, sparged with nitrogen, and heated to 55° C. Under a nitrogen blanket, initiator (Vazo™ 56, 0.03% by weight of total mixture in 0.86% by weight water) was added. The composition was mixed at 70° C. for 4 hours. The resulting polymer emulsion was applied onto fabric and tested according to the Test Methods above.

### Examples 17-22

Example 16 was repeated, except additives were included in the pad bath in the amounts shown below.

TABLE 4
Performance of Examples 16-22

| | | Spray | | Corn Oil | | Mineral Oil | |
|---|---|---|---|---|---|---|---|
| | | Rating | | Rating | | Rating | |
| | | | 10 | | 10 | | 10 |
| Ex. | Additive | Initial | HW | Initial | HW | Initial | HW |
| 16 | none | 50 | 25 | 3.5 | 4 | 3.5 | 3 |
| 17 | 5 g/L PHOBOL ® XAN | 70 | 70 | 4 | 4 | 3 | 3.5 |
| 18 | 5 g/L INVADINE ® | 60 | | 4 | | 3 | |
| | PBN | | | | | | |
| 19 | 50 g/L KNITTEX ® | 60 | | 4 | | 3.5 | |
| | 7636 | | | | | | |
| 20 | 1 g/L 60% acetic acid | 55 | | 3 | | 3 | |
| 21 | 20 g/L ULTRATEX ® | 75 | | 3 | | 2.5 | |
| | SI | | | | | | |
| 22 | 20 g/L TURPEX ® | 60 | | 3 | | 3 | |
| | ACN | | | | | | |

### Examples 23-25

Example 16 was repeated, using the silicone monomers listed.

### Example 26

Example 16 was repeated, using Silmer® ACR Di-1508 in place of the Silmer® ACR Di-2010-D and using hydroxyethyl methacrylate (HEMA) in place of 7EO MA. The resulting polymer emulsion was applied onto fabric and tested according to the Test Methods above.

TABLE 5
Performance of Examples 23-26

| | | Spray | Corn Oil | Mineral Oil |
|---|---|---|---|---|
| | | Rating | Rating | Rating |
| Ex. | Silicone Monomer | Initial | Initial | Initial |
| 23 | Silmer ® MACR Di-1508 | 25 | 4 | 4 |
| 24 | Silmer ® MACR Di-1010 | 65 | 3 | 2.5 |
| 25 | Silmer ® MACR D212-CG | 60 | 4.5 | 3.5 |
| 26 | Silmer ® ACR Di-1508 | 60 | 3.5 | 3 |

### Comparative Example D

Example 26 was repeated, using 16.35% by weight HEMA and no Silmer® ACR Di-1508. The resulting polymer gelled and was not able to be tested for performance.

### Examples 27-35

In a vessel, Silmer® ACR Di-1508 (4.09% by weight), 7EO MA (4.09% by weight), additional monomer (8.17% by weight), Armeen® DM18D (0.57% by weight), glacial acetic acid (0.46% by weight) and deionized water (81.73% by weight) were weighed. The contents were blended for 2 minutes on setting 3 in a blender. The mixture was added to a reactor, sparged with nitrogen, and heated to 55° C. Under a nitrogen blanket, initiator (Vazo™ 56, 0.03% by weight of total mixture in 0.86% by weight water) was added. The composition was mixed at 70° C. for 4 hours. The resulting polymer emulsions were applied onto fabric and tested according to the Test Methods above.

### Examples 36-38

Example 27 was repeated, except PHOBOL® XAN was added into the pad bath at 5 g/L.

TABLE 6
Performance of Examples 27-38

| | | Spray | | Corn Oil | | Mineral Oil | |
|---|---|---|---|---|---|---|---|
| | | Rating | | Rating | | Rating | |
| | | | 10 | | 10 | | 10 |
| Ex. | Additional Monomer | Initial | HW | Initial | HW | Initial | HW |
| 27 | n-butyl methacrylate | 50 | | 3 | | 3 | |
| 28 | ethyl hexyl | 60 | 60 | 3.5 | 3.5 | 4 | 4 |
| | methacrylate | | | | | | |
| 29 | isobutyl acrylate | 60 | | 3 | | 2.5 | |
| 30 | isopropyl methacrylate | 50 | | 2.5 | | 2.5 | |
| 31 | methyl methacrylate | 70 | 70 | 2.5 | 2.5 | 2 | 2.5 |
| 32 | t-butyl acrylate | 50 | | 3.5 | | 3 | |
| 33 | t-butyl methacrylate | 75 | | 3 | | 2.5 | |
| 34 | C13-methacrylate | 70 | 70 | 2.5 | 2.5 | 2 | 2.5 |
| 35 | IBOMA | 75 | 60 | 3.5 | 3.5 | 3 | 3 |
| 36 | methyl methacrylate | 75 | 70 | 3.5 | 4 | 3 | 3 |
| 37 | C13-methacrylate | 85 | | 2 | | 2 | |
| 38 | IBOMA | 85 | | 3 | | 3.5 | |

### Examples 39-69 and Comparative Examples E-H

Example 27 was repeated, using the monomers below. The amounts of DI water (81.71% by weight) and Vazo™ 56 (0.05% by weight) were changed from the procedure above. The resulting polymer emulsions were applied onto fabric and tested according to the Test Methods above. For Example 69 and Comparative Example H, 0.03% by weight of Vazo™ 56 was used.

TABLE 7
Components and Performance of Examples
39-69 and Comparative Examples E-H

| | Silmer ® | | | | | | |
|---|---|---|---|---|---|---|---|
| | ACR | 7EO | | | | Corn | Mineral |
| | Di-1508 | MA (% | IBOMA | HEMA | Spray | Oil | Oil |
| | (% by | by | (% by | (% by | Rating | Rating | Rating |
| Ex. | weight) | weight) | weight) | weight) | Initial | Initial | Initial |
| 39 | 1.08 | 6.60 | 8.66 | | 75 | 2.5 | 2 |
| 40 | 1.54 | 7.56 | 7.24 | | 85 | 2.5 | 2 |
| 41 | 4.58 | 4.43 | 7.33 | | 85 | 3 | 3 |
| 42 | 5.11 | 5.38 | 5.85 | | 60 | 3.25 | 2.5 |
| 43 | 5.93 | 4.83 | 5.58 | | 75 | 3 | 3 |
| 44 | 6.96 | 5.13 | 4.26 | | 55 | 3.5 | 2 |
| 45 | 8.69 | 3.12 | 4.54 | | 50 | 3.25 | 3.25 |
| 46 | 9.27 | 3.54 | 3.54 | | 60 | 2.5 | 3 |
| 47 | 10.91 | 2.40 | 3.03 | | 50 | 4 | 3 |
| 48 | 1.12 | | 8.99 | 6.23 | 75 | 2 | 2 |
| 49 | 1.61 | | 7.56 | 7.17 | 75 | 2 | 2 |
| 50 | 4.09 | | 4.09 | 8.17 | 85 | 3 | 2.5 |
| 51 | 4.70 | | 7.52 | 4.13 | 90 | 2.5 | 2.5 |
| 52 | 5.27 | | 6.03 | 5.04 | 85 | 3.5 | 3 |
| 53 | 5.93 | | 5.58 | 4.83 | 85 | 3 | 2.5 |
| 54 | 6.10 | | 5.74 | 4.51 | 85 | 2.75 | 2.5 |
| 55 | 7.17 | | 4.38 | 4.80 | 75 | 2.75 | 2.5 |
| 56 | 8.84 | | 4.62 | 2.88 | 85 | 3 | 3 |
| 57 | 9.46 | | 3.61 | 3.28 | 75 | 3 | 2.75 |
| 58 | 11.06 | | 3.07 | 2.21 | 75 | 2.75 | 3 |
| 59 | 1.10 | 3.36 | 8.82 | 3.06 | 75 | 2 | 2 |
| 60 | 1.57 | 3.86 | 7.40 | 3.51 | 85 | 2 | 2 |
| 61 | 4.64 | 2.25 | 7.42 | 2.04 | 85 | 3 | 2.5 |
| 62 | 5.11 | 2.69 | 5.84 | 4.06 | 85 | 3 | 2.5 |
| 63 | 6.01 | 2.45 | 5.66 | 2.22 | 70 | 3.5 | 3 |
| 64 | 7.06 | 2.60 | 4.32 | 2.36 | 75 | 3.25 | 3 |
| 65 | 8.76 | 1.57 | 4.58 | 1.43 | 70 | 3 | 3.25 |
| 66 | 9.36 | 1.79 | 3.58 | 1.62 | 75 | 3 | 3 |
| 67 | 10.98 | 1.21 | 3.05 | 1.10 | 75 | 3.5 | 3.5 |
| 68 | 4.89 | 0.65 | 10.33 | 0.47 | 75 | 2.5 | 2.5 |
| 69 | 1.84 | 2.72 | 6.40 | 5.38 | 75 | 2.5 | 2.5 |
| E | 0.00 | 4.71 | 11.63 | | 70 | 2 | 2 |
| F | 0.00 | 0.99 | 14.64 | 0.71 | 75 | 2 | 2 |
| G | 0.00 | 2.45 | 12.12 | 1.77 | 70 | 2 | 2 |
| H | 0.82 | 0.82 | 8.17 | 6.54 | 75 | 2.5 | 2.5 |

### Examples 70-73

Example 27 was repeated, using methyl methacrylate as the additional monomer and using the silicone monomers cited below.

### Examples 74-75

Example 27 was repeated, using methyl methacrylate as the additional monomer and using Blemmer® ADE-400A instead of 7EO MA. In Example 75, PHOBOL® XAN was added to the pad bath at 5 g/L.

TABLE 8
Performance of Examples 70-75

| | | Spray | Corn Oil | Mineral Oil |
|---|---|---|---|---|
| | | Rating | Rating | Rating |
| Ex. | Silicone Monomer | Initial | Initial | Initial |
| 70 | Silmer ® MACR Di-1508 | 75 | 3.5 | 3 |
| 71 | Silmer ® MACR Di-1010 | 60 | 3 | 2.75 |
| 72 | Silmer ® MACR D212-CG | 50 | 3 | 2.75 |
| 73 | Silmer ® MACR Di-1017 | 0 | 4 | 2.75 |
| 74 | Silmer ® MACR Di-1508 | 50 | 3.5 | 3 |
| 75 | Silmer ® MACR Di-1508 | 50 | 3.5 | 3 |

### Examples 76-77

In a vessel, Silmer® ACR Di-1508 (4.09% by weight), methyl methacrylate (12.26% by weight), Armeen® DM18D (0.57% by weight), glacial acetic acid (0.46% by weight) and deionized water (81.73% by weight) were weighed. The contents were blended for 2 minutes on setting 3 in a blender. The mixture was added to a reactor, sparged with nitrogen, and heated to 55° C. Under a nitrogen blanket, initiator (Vazo™ 56, 0.03% by weight of total mixture in 0.86% by weight water) was added. The composition was mixed at 70° C. for 4 hours. The resulting polymer emulsions were applied onto fabric and tested according to the Test Methods above. In Example 77, PHOBOL® XAN was added to the pad bath at 5 g/L.

### Example 78

Example 76 was repeated, using Silmer® ACR Di-1010 instead of Silmer® ACR Di-1508.

TABLE 9
Performance of Examples 76-78

| | Spray Rating | Corn Oil Rating | Mineral Oil Rating |
|---|---|---|---|
| Ex. | Initial | Initial | Initial |
| 76 | 85 | 2 | 2.5 |
| 77 | 85 | 2.5 | 2.5 |
| 78 | 75 | 3 | 3 |

### Examples 79-82

Example 27 was repeated, using ethylhexyl methacrylate as the additional monomer and using the monomers below in place of 7EO MA. The resulting polymer emulsions were applied onto fabric and tested according to the Test Methods above.

### Examples 83-84

Example 79 was repeated, using 4.09% by weight of ethylhexyl methacrylate and using 8.17% by weight of the monomers below.

TABLE 10
Performance of Examples 79-84

| | | Spray | Corn Oil | Mineral Oil |
|---|---|---|---|---|
| | | Rating | Rating | Rating |
| Ex. | Monomer | Initial | Initial | Initial |
| 79 | HEMA | 75 | 2 | 2.5 |
| 80 | Blemmer ® PE-90 | 75 | 2.5 | 3 |
| 81 | glycidyl methacrylate | 85 | 2 | 2 |
| 82 | Blemmer ® GLM | 85 | 2.5 | 2.5 |
| 83 | HEMA | 75 | 3 | 2.75 |
| 84 | hydroxypropyl | 75 | 3 | 2.5 |
| | methacrylate | | | |

### Examples 85-86

Example 16 was repeated, using Silmer® ACR Di-1508 instead of Silmer® ACR Di-2010-D, and using Blemmer® PLE-200 instead of 7EO MA. In Example 86, PHOBOL® XAN was added to the pad bath at 5 g/L.

### Example 87

Example 16 was repeated, using Silmer® ACR Di-1010 instead of Silmer® ACR Di-2010-D, and using Blemmer® AME-400 instead of 7EO MA. PHOBOL® XAN was added to the pad bath at 5 g/L.

### Examples 88-89

Example 16 was repeated, using CD9075 instead of 7EO MA. In Example 89, PHOBOL® XAN was added to the pad bath at 5 g/L.

### Example 90

Example 27 was repeated, using Blemmer® VMA-70 as the additional monomer and using Silmer© ACR Di-1010 instead of Silmer® ACR Di-2010-D.

### Example 91

In a vessel, Silmer® ACR Di-2010-D (7.84% by weight), dodecyl mercaptan (0.01% by weight), ethylene glycol dimethacrylate (1.96% by weight), Armeen® DM18D (0.57% by weight), glacial acetic acid (0.46% by weight) and deionized water (81.65% by weight) were weighed. The contents were blended for 2 minutes on setting 3 in a blender. The mixture was added to a reactor, sparged with nitrogen, and heated to 55° C. Under a nitrogen blanket, initiator (Vazo™ 56, 0.03% by weight of total mixture in 0.86% by weight water) was added. The composition was mixed at 70° C. for 2.5 hours. At this point, a mixture of ethylhexyl methacrylate (3.27% by weight), IBOMA (2.94% by weight), and 7EO MA (0.33% by weight) were added to the reactor over 10 minutes. Additional Vazo™ 56 (0.003% by weight of total mixture in 0.09% by weight water) were added. The composition was mixed at 70° C. for 4 hours. The resulting polymer emulsions were applied onto fabric and tested according to the Test Methods above.

### Example 92

Example 91 was repeated, using ethylhexyl methacrylate (6.53% by weight) and omitting IBOMA and 7EO MA in the second stage.

TABLE 11
Performance of Examples 85-92

| | Spray Rating | Corn Oil Rating | Mineral Oil Rating |
|---|---|---|---|
| Ex. | Initial | Initial | Initial |
| 85 | 60 | 3.5 | 3 |
| 86 | 60 | 3.5 | 3.5 |
| 87 | 75 | 2.5 | 2.5 |
| 88 | 60 | 3.5 | 3 |
| 89 | 60 | 3 | 3 |
| 90 | 55 | 3.5 | 3.5 |
| 91 | 70 | 2 | 2 |
| 92 | 75 | 2 | 2 |

### Examples 93-95

Example 27 was repeated, using Silmer® MACR Di-1508 instead of Silmer® ACR Di-1508 and using the monomers in the table below.

TABLE 12
Performance of Examples 93-95

| | | Spray | Corn Oil | Mineral Oil |
|---|---|---|---|---|
| | | Rating | Rating | Rating |
| Ex. | Monomer | Initial | Initial | Initial |
| 93 | isobutyl acrylate | 60 | 3 | 3 |
| 94 | IBOMA | 75 | 2.5 | 2.5 |
| 95 | t-butyl acrylate | 60 | 3.5 | 3.5 |

### Examples 96-97

In a vessel, Silmer® MACR D208 (10.99% by weight), 7EO MA (1.21% by weight), hydroxyethyl methacrylate (1.10% by weight), IBOMA (3.05% by weight), Armeen® DM18D (0.57% by weight), glacial acetic acid (0.46% by weight) and deionized water (81.73% by weight) were weighed. The contents were blended for 2 minutes on setting 3 in a blender. The mixture was added to a reactor, sparged with nitrogen, and heated to 55° C. Under a nitrogen blanket, initiator (Vazo™ 56, 0.04% by weight of total mixture in 0.86% by weight water) was added. The composition was mixed at 70° C. for 4 hours. The resulting polymer emulsions were applied onto fabric and tested according to the Test Methods above. In Example 97, PHOBOL® XAN was added to the pad bath at 5 g/L.

### Example 98

In a vessel, Silmer® MACR D208 (11.44% by weight), 7EO MA (3.27% by weight), vinylidene chloride (1.63% by weight), Armeen® DM18D (0.57% by weight), glacial acetic acid (0.46% by weight) and deionized water (81.72% by weight) were weighed. The contents were blended for 2 minutes on setting 3 in a blender. The mixture was added to a reactor, sparged with nitrogen, and heated to 55° C. Under a nitrogen blanket, initiator (Vazo™ 56, 0.05% by weight of total mixture in 0.86% by weight water) was added. The composition was mixed at 70° C. for 4 hours. The resulting polymer emulsions were applied onto fabric and tested according to the Test Methods above.

### Example 99

In a vessel, Silmer® MACR D208 (12.07% by weight), HEMA (2.73% by weight), vinylidene chloride (0.82% by weight), Tergitol® TMN-10 (0.43% by weight), Armeen® DM18D (0.57% by weight), glacial acetic acid (0.46% by weight) and deionized water (82.01% by weight) were weighed. The contents were blended for 2 minutes on setting 3 in a blender. The mixture was added to a reactor, sparged with nitrogen, and heated to 55° C. Under a nitrogen blanket, initiator (Vazo™ 56, 0.05% by weight of total mixture in 0.87% by weight water) was added. The composition was mixed at 70° C. for 4 hours. The resulting polymer emulsions were applied onto fabric and tested according to the Test Methods above.

### Example 100

In a vessel, Silmer® ACR Di-1508 (10.99% by weight), HEMA (1.10% by weight), 7EO MA (1.21% by weight), ethylhexyl methacrylate (3.05% by weight), Armeen® DM18D (0.57% by weight), glacial acetic acid (0.46% by weight) and deionized water (81.73% by weight) were weighed. The contents were blended for 2 minutes on setting 3 in a blender. The mixture was added to a reactor, sparged with nitrogen, and heated to 55° C. Under a nitrogen blanket, initiator (Vazo™ 56, 0.04% by weight of total mixture in 0.86% by weight water) was added. The composition was mixed at 70° C. for 4 hours. The resulting polymer emulsions were applied onto fabric and tested according to the Test Methods above.

### Example 101

In a vessel, Silmer® ACR Di-1508 (10.77% by weight), HEMA (1.08% by weight), 7EO MA (1.19% by weight), ethylhexyl methacrylate (2.99% by weight), Arquad® 16-50 (3.00% by weight), and deionized water (80.09% by weight) were weighed. The contents were blended for 2 minutes on setting 3 in a blender. The mixture was added to a reactor, sparged with nitrogen, and heated to 55° C. Under a nitrogen blanket, initiator (Vazo™ 56, 0.03% by weight of total mixture in 0.85% by weight water) was added. The composition was mixed at 70° C. for 4 hours. The resulting polymer emulsions were applied onto fabric and tested according to the Test Methods above.

### Example 102

Example 16 was repeated, using Silmer® MACR D212-CG in place of the Silmer® ACR Di-2010-D and using hydroxyethyl methacrylate (HEMA) in place of 7EO MA. The resulting polymer emulsion was applied onto fabric and tested according to the Test Methods above.

### Example 103

Example 102 was repeated, using Arquad® 16-29 instead of Armeen DM18D. Also, only 0.04% by weight of Vazo® 56 was used. The resulting polymer emulsion was applied onto fabric and tested according to the Test Methods above.

### Example 104

Example 16 was repeated, using Silmer® ACR D208 in place of the Silmer® ACR Di-2010-D and using hydroxyethyl methacrylate (HEMA) in place of 7EO MA. The resulting polymer emulsion was applied onto fabric and tested according to the Test Methods above.

### Example 105

Example 104 was repeated, using Arquad® 16-29 instead of Armeen DM18D. The resulting polymer emulsion was applied onto fabric and tested according to the Test Methods above.

TABLE 13
Performance of Examples 96-105

| | Spray Rating | | Corn Oil Rating | | Mineral Oil Rating | |
|---|---|---|---|---|---|---|
| Ex. | Initial | 10 HW | Initial | 10 HW | Initial | 10 HW |
| 96 | 75 | 50 | 4 | 4 | 3.5 | 3.5 |
| 97 | 70 | 75 | 4 | 3.5 | 3.5 | 3.25 |
| 98 | 50 | 50 | 3 | 4 | 2.75 | 4 |
| 99 | 50 | 50 | 4 | 5 | 5 | 4 |
| 100 | 50 | 50 | 3.25 | 3.5 | 3 | 3 |
| 101 | 50 | 50 | 3 | 3.25 | 3 | 3 |
| 102 | 75 | 50 | 4 | 3.5 | 3.5 | 3.25 |
| 103 | 50 | 25 | 3.5 | 3.5 | 4 | 3 |
| 104 | 70 | 60 | 4 | 4 | 3.5 | 3.5 |
| 105 | 50 | 50 | 3.25 | 4 | 3 | 4 |

### Examples 106-121

The products of different examples were blended according to the table below. The % by weight of each component was based on the solids content of that component. The blended product was then diluted to 20% solids. PHOBOL® XAN was added to the pad bath at 5 g/L, except for Examples 112-114 and 119-121.

TABLE 14
Composition of Examples 106-121

| | | Product 1 | | Product 2 |
|---|---|---|---|---|
| Ex. | Product 1 | (% by weight) | Product 2 | (% by weight) |
| 106 | Example 67 | 76.3 | Example 25 | 23.7 |
| 107 | Example 67 | 17.6 | Example 25 | 82.4 |
| 108 | Example 67 | 79.6 | Example 25 | 20.4 |
| 109 | Example 67 | 83.7 | Example 25 | 16.3 |
| 110 | Example 67 | 82.0 | Example 25 | 18.0 |
| 111 | Example 67 | 84.5 | Example 25 | 15.5 |
| 112 | Example 96 | 21.5 | Example 100 | 78.5 |
| 113 | Example 96 | 22.7 | Example 101 | 87.3 |
| 114 | Example 96 | 21.5 | Example 28 | 78.5 |
| 115 | Example 96 | 12.1 | Example 98 | 87.9 |
| 116 | Example 96 | 21.8 | Example 105 | 78.2 |
| 117 | Example 96 | 21.5 | Example 103 | 79.5 |
| 118 | Example 96 | 20.0 | Example 104 | 80.0 |
| 119 | Example 101 | 85.8 | Zelan ™ R3 | 14.2 |
| 120 | Example 28 | 86.6 | Zelan ™ R3 | 13.4 |
| 121 | Example 100 | 86.6 | Zelan ™ R3 | 13.4 |

TABLE 15
Performance of Examples 106-121

| | Spray Rating | | Corn Oil Rating | | Mineral Oil Rating | |
|---|---|---|---|---|---|---|
| Ex. | Initial | 10 HW | Initial | 10 HW | Initial | 10 HW |
| 106 | 85 | | 4 | | 3 | |
| 107 | 75 | | 3.25 | | 3.5 | |
| 108 | 75 | 75 | 3.5 | 3 | 3 | 2.5 |
| 109 | 75 | 70 | 4 | 3.5 | 4 | 4 |
| 110 | 75 | 75 | 4 | 3.5 | 4 | 3.5 |
| 111 | 75 | 75 | 4 | 3.5 | 4 | 3.5 |
| 112 | 50 | 50 | 3.25 | 3.25 | 3.25 | 3 |
| 113 | 50 | 50 | 3.25 | 3.25 | 3 | 2.5 |
| 114 | 75 | 60 | 3 | 2.5 | 3 | 2.5 |
| 115 | 50 | 60 | 3.5 | 3.25 | 3.5 | 3 |
| 116 | 70 | 75 | 3.5 | 3.25 | 3.25 | 3 |
| 117 | 75 | 75 | 3 | 2.5 | 3 | 2.5 |
| 118 | 70 | 75 | 4 | 3.5 | 3.5 | 3.25 |
| 119 | 50 | 50 | 3.25 | 3.25 | 3 | 3 |
| 120 | 70 | 85 | 3 | 2.75 | 2.5 | 2.5 |
| 121 | 50 | 50 | 2.5 | 2.5 | 2.75 | 3 |

1. A treated substrate comprising a fibrous substrate and a treatment composition applied on the fibrous substrate, wherein the treatment composition comprises
a) about 20-99.5% by weight of a silicone polyether polymer, and
b) about 0.5-4% by weight of at least one surfactant selected from at least one cationic surfactant or a mixture of at least one cationic and at least one nonionic surfactant, all based on the total dry weight of the treatment composition;
wherein the silicone polyether polymer has about 6 to about 100% by weight of repeat units from formula (I) or formula (II) and about 0% to about 94% by weight of repeat units from ethylenically unsaturated comonomers, all based on the total weight of the polymer; 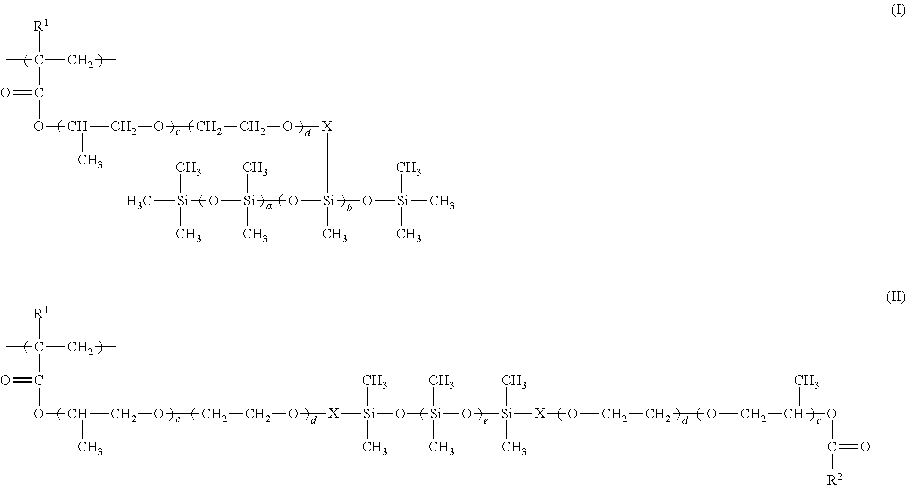
wherein
a and b are independently integers of 1 to 40 where a+b is an integer of at least 2;
c and d are independently integers of 0 to 20;
e is an integer of 1 to 40;
X is a linear or branched C₁-C₄ alkylene group;
R¹ is a C₁-C₄ alkyl group; and
R² is —C(R¹)═CH₂ or polymer backbone unit —[C(R¹)—CH₂]— bonded at C(R¹);
provided that if c+d is 0, then the silicone polyether polymer has repeat units from at least one ethylenically unsaturated comonomer having at least one pendant alkoxylate group.

2. The treated substrate of claim 1, where the polymer has about 10 to about 100% by weight repeat units from formula (I) or formula (II) and about 0 to about 90% by weight repeat units from ethylenically unsaturated comonomers.

3. The treated substrate of claim 1, where the polymer has about 40 to about 100% by weight repeat units from formula (I) or formula (II) and about 0 to about 60% by weight repeat units from ethylenically unsaturated comonomers.

4. The treated substrate of claim 1, where the polymer has about 100% by weight repeat units from formula (I) or formula (II).

5. The treated substrate of claim 1, where the ethylenically unsaturated comonomers are present and selected from alkoxylated (meth)acrylates, alkoxylated (meth)acrylamides, hydroxyalkyl (meth)acrylates, hydroxyalkyl (meth)acrylamides, glycidyl (meth)acrylates, cyclic hydrocarbon (meth)acrylates, linear or branched alkyl (meth)acrylates, vinylidene halide, vinyl halide, vinyl acetate, diacetone (meth)acrylamide, glycidyl (meth)acrylamides, cyclic hydrocarbon (meth)acrylamides, linear or branched alkyl (meth)acrylamides, or mixtures thereof.

6. The treated substrate of claim 5, where the silicone polyether polymer has repeat units from copolymerizing:
at least one monomer selected from alkoxylated (meth)acrylates, alkoxylated (meth)acrylamides, hydroxyalkyl (meth)acrylates, hydroxyalkyl (meth)acrylamides, glycidyl (meth)acrylates, or mixtures thereof; and
at least one additional monomer selected from cyclic hydrocarbon (meth)acrylates, linear or branched alkyl (meth)acrylates, vinylidene halide, vinyl halide, vinyl acetate, diacetone (meth)acrylamide, glycidyl (meth)acrylamides, cyclic hydrocarbon (meth)acrylamides, linear or branched alkyl (meth)acrylamides, or mixtures thereof.

7. The treated substrate of claim 1, where the treatment composition further comprises a hydrophobic surface effect agent selected from the group consisting of fatty acid ester of cyclic or acyclic polyols, fatty esters of polycarboxylic acids, hydrophobic non-fluorinated (meth)acrylic polymers, partially fluorinated urethanes, hydrophobic non-fluorinated urethanes, partially fluorinated (meth)acrylic polymers or copolymers, partially fluorinated (meth)acrylamide polymers or copolymers, fluorinated phosphates, fluorinated ethoxylates, fluorinated or non-fluorinated organosilanes, silicones, waxes, including parafins, and mixtures thereof.

8. The treated substrate of claim 1, where the treatment composition is non-fluorinated.

9. The treated substrate of claim 1, wherein the treatment composition comprises a) about 20-95% by weight of a silicone polyether polymer, b) about 0.5-4% by weight of at least one surfactant, and c) about 1-79.5% by weight of a hydrophobic surface effect agent, all based on the total dry weight of the treatment composition.

10. A process of providing a surface effect to a substrate comprising contacting a treatment composition with a fibrous substrate, wherein the treatment composition comprises
a) about 20-99.5% by weight of a silicone polyether polymer, and
b) about 0.5-4% by weight of at least one surfactant selected from at least one cationic surfactant or a mixture of at least one cationic and at least one nonionic surfactant all based on the total dry weight of the treatment composition;
wherein the silicone polyether polymer has about 6 to about 100% by weight of repeat units from formula (I) or formula (II) and about 0% to about 94% by weight of repeat units from ethylenically unsaturated comonomers, all based on the total weight of the polymer; 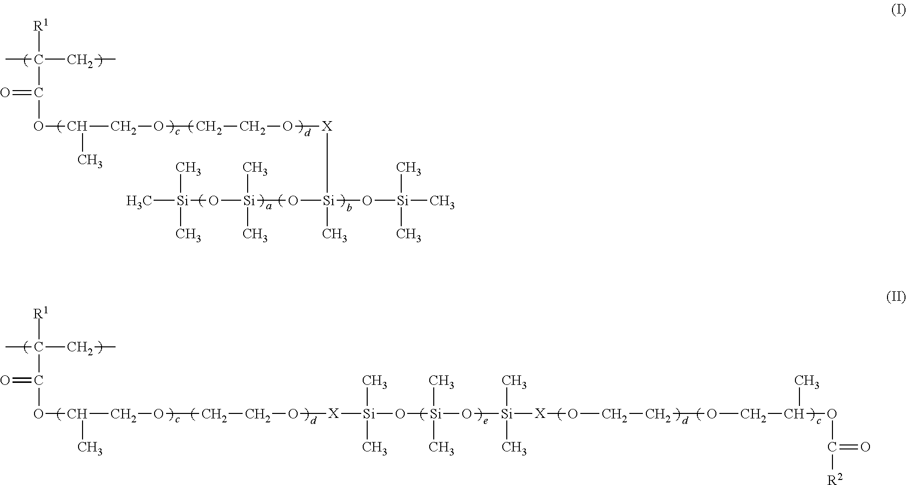
wherein
a and b are independently integers of 1 to 40 where a+b is an integer of at least 2;
c and d are independently integers of 0 to 20;
e is an integer of 1 to 40;
X is a linear or branched C₁-C₄ alkylene group;
R¹ is a C₁-C₄ alkyl group; and
R² is —C(R¹)═CH₂ or polymer backbone unit —[C(R¹)—CH₂]— bonded at C(R¹);
provided that if c+d is 0, then the silicone polyether polymer has repeat units from at least one ethylenically unsaturated comonomer having at least one pendant alkoxylate group.

11. The process of claim 10, where the polymer has about 10 to about 100% by weight repeat units from formula (I) or formula (II) and about 0 to about 90% by weight repeat units from ethylenically unsaturated comonomers.

12. The process of claim 10, where the polymer has about 40 to about 100% by weight repeat units from formula (I) or formula (II) and about 0 to about 60% by weight repeat units from ethylenically unsaturated comonomers.

13. The process of claim 10, where the polymer has about 100% by weight repeat units from formula (I) or formula (II).

14. The process of claim 10, where the ethylenically unsaturated comonomers are present and selected from alkoxylated (meth)acrylates, alkoxylated (meth)acrylamides, hydroxyalkyl (meth)acrylates, hydroxyalkyl (meth)acrylamides, glycidyl (meth)acrylates, cyclic hydrocarbon (meth)acrylates, linear or branched alkyl (meth)acrylates, vinylidene halide, vinyl halide, vinyl acetate, diacetone (meth)acrylamide, glycidyl (meth)acrylamides, cyclic hydrocarbon (meth)acrylamides, linear or branched alkyl (meth)acrylamides, or mixtures thereof.

15. The process of claim 14, where the silicone polyether polymer has repeat units from copolymerizing:
at least one monomer selected from alkoxylated (meth)acrylates, alkoxylated (meth)acrylamides, hydroxyalkyl (meth)acrylates, hydroxyalkyl (meth)acrylamides, glycidyl (meth)acrylates, or mixtures thereof; and
at least one additional monomer selected from cyclic hydrocarbon (meth)acrylates, linear or branched alkyl (meth)acrylates, vinylidene halide, vinyl halide, vinyl acetate, diacetone (meth)acrylamide, glycidyl (meth)acrylamides, cyclic hydrocarbon (meth)acrylamides, linear or branched alkyl (meth)acrylamides, or mixtures thereof.

16. The process of claim 10, where the treatment composition further comprises fatty acid esters of cyclic or acyclic polyols, fatty esters of polycarboxylic acids, hydrophobic non-fluorinated (meth)acrylic polymers, partially fluorinated urethanes, hydrophobic non-fluorinated urethanes, partially fluorinated (meth)acrylic polymers or copolymers, partially fluorinated (meth)acrylamide polymers or copolymers, fluorinated phosphates, fluorinated ethoxylates, fluorinated or non-fluorinated organosilanes, silicones, waxes, including parafins, and mixtures thereof.

17. The process of claim 10, where the treatment composition is non-fluorinated.

18. The process of claim 10, where the contacting step occurs by exhaustion, foam, flex-nip, nip, pad, kiss-roll, beck, skein, winch, liquid injection, overflow flood, brush, spraying, rolling, dip-squeeze, painting, dripping, immersing, powder coating, tumbling, or screen printing.

19. The process of claim 10, where the contacting step occurs inside a laundry machine.

20. The process of claim 10, wherein the treatment composition comprises a) about 20-95% by weight of a silicone polyether polymer, b) about 0.5-4% by weight of at least one surfactant, and c) about 1-79.5% by weight of a hydrophobic surface effect agent, all based on the total dry weight of the treatment composition.
